(19) United States
(12) Patent Application Publication
(10) Pub. No.: US 2004/0153353 A1
(43) Pub. Date: Aug. 5, 2004

(54) Method for network-based realization of a project proposal as a project

(76) Inventors: Michael Maschke, Lonnerstadt (DE); Siegfried Schneider, Bamberg (DE)

Correspondence Address: SCHIFF HARDIN & WAITE, Patent Department, 6600 Sears Tower, 233 South Wacker Drive, Chicago, IL, 60606, US

(21) Appl. No.: 10/656,396

(22) Filed: Sep. 5, 2003

(30) Foreign Application Priority Data
Sep. 6, 2002 (DE) 102 41 427.0

(51) Int. Cl. G06F 17/60

(52) U.S. Cl. 705/8

(57) ABSTRACT

The invention concerns methods for network-supported realization of a project based on a project proposal, for the realization of which a sequence of successive work steps to be implemented is provided. On a first computer, a first electronic page is provided that can be loaded onto a second computer via an information transmission network. The first electronic page comprises a field with which the project proposal is documented. After the documentation, an electronic file is created, and subsequently the persons provided for the processing of the project proposal are automatically informed about the project proposal with electronic messages.

### BACKGROUND OF THE INVENTION

The invention concerns a method for a network-assisted realization of a project based on a project proposal, for whose realization a sequence of successive work steps is provided.

The future of business is substantially dependent on how innovations are controlled, i.e., how quickly and how many project proposals are generated and evaluated, and how quickly and how many promising project proposals are realized as a project. A project is defined here as a new development or further development of a product such as a device, a system, or a computer program. The path from the project proposal to the product definition is frequently dependent on the competence of individual contributors or employees. Luck, chance, or intuition can occasionally play a role in the definition of promising products.

### SUMMARY OF THE INVENTION

The object of the invention is therefore to provide a method that automatically assists an evaluation of a project proposal and a subsequent realization of a project based on the project proposal.

The object of the invention is achieved by a method for network-assisted realization of a project based on a project proposal, for the realization of which are provided a sequence of successive work steps to be implemented, comprising the following method steps:

providing a first electronic page that can be loaded from a first computer with a second computer via an information transfer network and that comprises at least one field in which a project proposal can be entered with the second computer;

automatically creating an electronic file comprising the project proposal, after which the project proposal would be registered in the field;

automatically producing a first electronic message about the electronic file and automatically transmitting the first electronic message to a first person that implements the first work step;

assigning the electronic file to a second person from a first group of people that implements the second work step;

automatically producing a second electronic message about the electronic file, and automatically transmitting the second electronic message to the second person;

automatically producing a further electronic message about the electronic file, and automatically transmitting the further electronic message to a further person or a further group of people that should implement the work step of the sequence of work steps that follows the preceding implemented work step.

According to an embodiment of the invention, the prepared first electronic page comprises a field in which the project proposal is entered. If the first electronic page is, for example, prepared by an industrial enterprise, then an employee of the industrial enterprise can, for example, load the first electronic page from the first computer with the second computer via the information transmission network (which is then, for example, an intranet of the industrial enterprise) in order to document a project proposal in the field. A project proposal is defined here as a proposal for a new project. A project proposal is thus a proposal to develop a new product or to further develop an existing product.

After filling in the project proposal, the electronic file is automatically created and the first person is informed about the created electronic file via the first electronic message (that is, for example, an automatically generated e-mail). Within the framework of the first work step of the sequence of work steps, the first person thereupon assigns the electronic file, i.e., the project proposal, to a second person (for example, based on the theme complexity of the project proposal). With that, the sequence of work steps begins for the realization of the project proposal as a project. The assignment of the electronic file to a second person is the first work step in this sequence.

So that the second person is informed of the electronic file, the second electronic message (that again can possibly be an e-mail) is automatically generated and transmitted to the second person, based on the assignment. For example, the second person may be responsible for undertaking a pre-evaluation of the project proposal in order, for example, to assess using previously determined criteria whether the project proposal should be realized at all as a project. Thus not only is the employee enabled to document his or her project proposal in a relatively simple manner, but steps are also commenced for the possible realization of the project proposal, such as the automatic informing of the first person.

The second person implements the next work step of the sequence of work steps for the realization of the project proposal as a project. When he or she has finished his or her work step, once again an electronic message about the electronic file is automatically generated and transmitted to the further person or the group of people. The further person or the group of people implement the next work step for the realization of the project. Therefore, the further automatic message about the electronic file is automatically produced and automatically transmitted to the further person or the further group of people that should implement the work step of the sequence of work steps that follows the previously implemented work step.

The object of the invention is also achieved by a method for network-assisted realization of a project based on a project proposal, for whose realization a sequence of successively implemented work steps is provided that comprises the following method steps:

providing a first electronic page that can be loaded from a first computer by a second computer via an information transmission network, and that comprises at least one field in which a project proposal can be entered with the second computer;

automatically creating an electronic file comprising the project proposal after the project proposal was entered into the field;

automatically assigning the electronic file to a person from a group of people;

automatically producing an electronic message about the electronic file, and automatically transmitting the electronic message to the person that implements the first work step of the sequence of work steps;

automatically producing a further electronic message about the electronic file, and automatically transmitting the further electronic message to a further person or a further group of people that should implement the work step of the sequence of work steps that follows the previously implemented work step.

Similar to the inventive method further specified above, in an embodiment, the first electronic page is again provided. It can again be loaded from the first computer with the second computer via the information transmission network such that the employee of the industrial enterprise or company can document his/her project proposal in a simple manner.

After filling out the field with the project proposal, the electronic file is again created. In contrast to the embodiment described above, the electronic file is thereupon automatically assigned to the person from the group of people. The electronic file is, for example, assigned to the person based on a theme complexity of the project proposal, in that, for example, for the assignment the project proposal is automatically scanned with a text recognition system. After the assignment, the person is automatically informed about the electronic file, and thus about the project proposal, in order to implement the first work step for a possible realization of the project proposal as a project. The first work step is, for example, an evaluation of the project proposal based on predetermined criteria, upon the basis of which it is decided whether the project proposal should be realized as a project at all.

After the person has finished the first work step, the person or group of people assigned to the next work step is automatically informed about the electronic file, so that he/she/it can implement the next work step.

So that implemented work steps are documented in a relatively convenient way, an embodiment is provided to augment the electronic file during at least one of the work steps.

According to a further embodiment of the invention, a second electronic page is provided on which the work steps of the sequence of work steps to be implemented are summarized. The second electronic page is, for example, stored in the first computer and can be loaded via the information transmission network with a computer connected to the information transmission network.

In order to particularly quickly provide an overview of the progress of the realization of the project, the second electronic page according to a preferred embodiment of the invention comprises information about the current work step to be implemented.

According to a further embodiment of the invention, a third electronic page is provided that comprises at least one instruction for at least one work step of the sequence of work steps. The third electronic page is, for example, again stored in the first computer, and can be loaded with a computer connected to the information transmission network.

An advantage of the inventive method is that the entire process from the project proposal to the realization of the project can be fashioned, specified, controlled, measured, and implemented in an electronically structured manner. As an information transmission network, for example, an intranet of the industrial enterprise or the internet, can be used. Thus in particular, project proposals for a project can be generated, evaluated, and further pursued in a simple manner. One of the work steps of the sequence of work steps is, for example, a decision about the realization or the further pursuit of the project, such that project proposals or, respectively, projects that in particular exhibit a good commercial prognosis, are introduced to a decision panel at specific points in time and, after a positive decision, are systematically and efficiently guided to the next work step with appropriate resources.

### DESCRIPTION OF THE DRAWINGS

An exemplary embodiment of the invention is shown in an exemplary fashion in the schematic figures.

FIG. 1 is a pictorial diagram of a scenario illustrative of the inventive method;

FIG. 2 is a screen shot of an exemplary opening screen;

FIG. 3 is a screen shot for an exemplary applicant data entry form;

FIG. 4 is a screen shot for an exemplary submission status response;

FIG. 5 is a screen shot for an exemplary project proposal entry screen;

FIG. 6 is a screen shot for an exemplary project proposal status response;

FIG. 7 is a screen shot that may be used for processing the project proposal;

FIG. 8 is a screen shot for an exemplary responsible employee entry form;

FIG. 9 is a screen shot for an exemplary evaluator entry form;

FIG. 10 is a screen shot for an exemplary evaluation form;

FIG. 11 is a screen shot for an exemplary evaluative assessment form;

FIG. 12 is a screen shot for an exemplary feasibility data entry form;

FIG. 13 is a screen shot illustrating a functional outline of system structure;

FIG. 14 is a screen shot of an additional employee project assessment form;

FIG. 15 is a screen shot of an exemplary status summary;

FIG. 16 is a block diagram illustrating the idea to requirement specification;

FIG. 17 is a screen shot of an exemplary summary product form;

FIGS. 18A, B are a top and bottom half, respectively, of a project proposal summary form, as illustrated by FIG. 18.

### DETAILED DESCRIPTION OF THE PREFERRED EMBODIMENTS

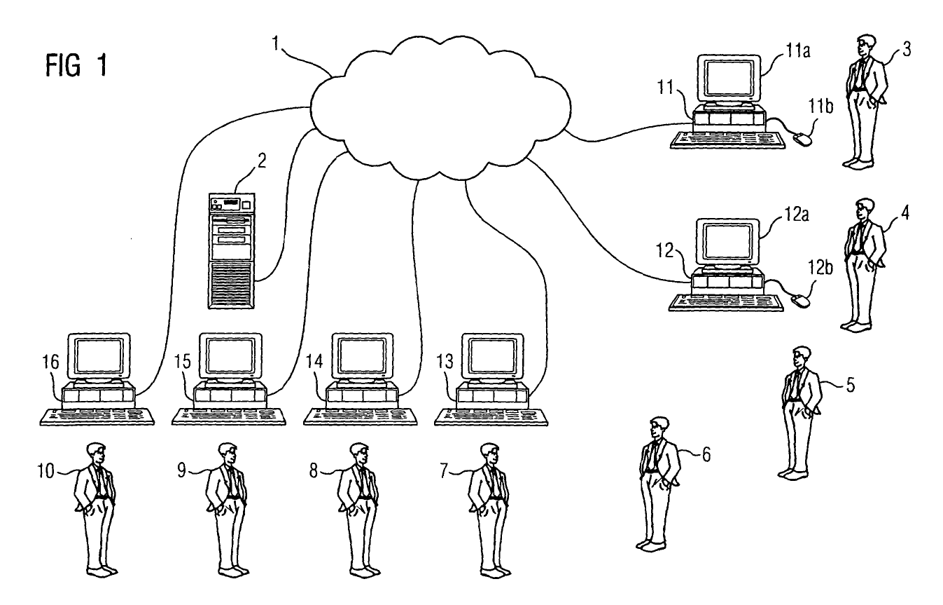

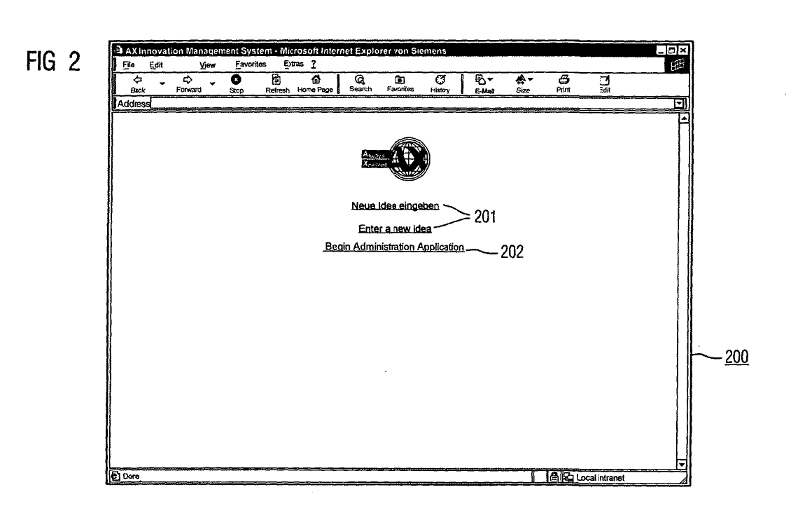

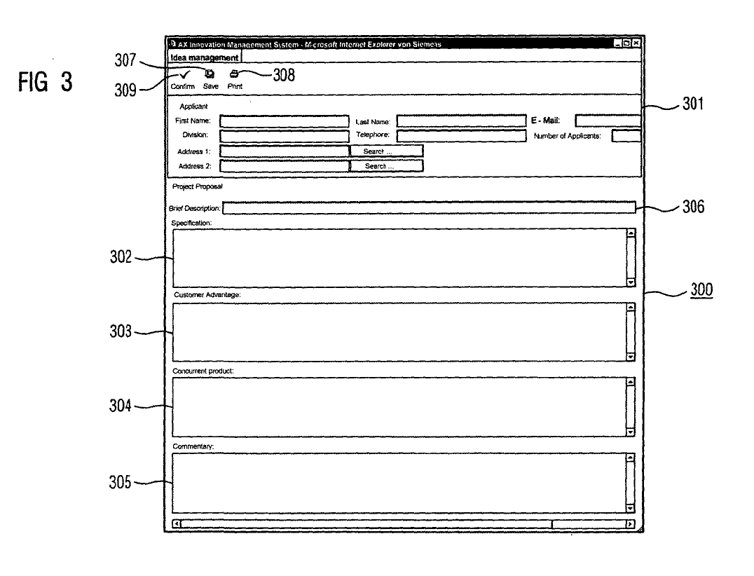

FIG. 1 shows a server 2 (connected to an information transmission network 1) that, in the case of the present exemplary embodiment, belongs to an industrial enterprise. In the server 2, an electronic page 300 shown in FIG. 3 is stored that, in the case of the exemplary embodiment, is composed in the HyperText Markup Language (HTML) format, and can be loaded by employees of the industrial enterprise with a computer connected to the information transmission network 1. Exemplary employees 3 through 11 are shown in FIG. 1.

The electronic page 300 is provided so that employees of the industrial enterprise can document their ideas with regard to the further development of a product (not shown in the figures) offered by the industrial enterprise, or a new development of a product potentially interesting for the industrial enterprise. The electronic page 300 is thus provided to submit a project proposal that will possibly be realized as a project. For the processing of the project proposal or, respectively, the possible realization as a project, a sequence of work steps is provided. Each work step of the sequence is moreover assigned to a person or a group of people that then is also designated as Process Owner.

In order that one of the employees who would like to document a project proposal can load the electronic page 300, he or she must first (in the case of the present exemplary embodiment) start a commonly known browser, such as Microsoft's Internet Explorer, with a computer connected to the information transmission network 1, such as the Internet or an intranet, and subsequently access an electronic page 200 (shown in FIG. 2) in which he or she selects the corresponding link of the electronic page 200. The electronic page 200 may be stored in the server 2.

In the case of the present exemplary embodiment, the employee 3 wishes to submit a project proposal, wherefore he or she accesses the electronic page 200 with a computer 11 accessible to him or her and connected to the information transmission network 1. He or she can thereupon view the electronic page 200 (that, in the case of the present exemplary embodiment, is likewise composed in the HTML format) with a monitor 11a connected to the computer 11.

The electronic page 200 comprises a link 201 indicated by “Neue Idee eingeben” or, respectively, “Enter a new idea” (multiple languages could be utilized and displayed from this entry screen). Upon activation of the link 201 (for example in that the employee 3 clicks on it with a computer mouse 11b connected to the computer 11) the electronic page 300 is loaded from the server 2 to the computer 11.

The electronic page 300 comprises, in the case of the present exemplary embodiment, a set of fields 301 in which the employee 2 should enter personal data such as his or her name, his or her work telephone number, or his or her work e-mail address. The set of fields 301 is also provided for the attachment of possible attachments for the clarification of the project proposal of the employee 3.

Furthermore, the electronic page 300 comprises a field 302 in which the employee 3 enters his or her project proposal in the form of text, i.e., the field 302 is provided for the specification of the project proposal. Furthermore, the electronic page 300, in the case of the present exemplary embodiment, comprises other fields 303 through 305, the filling out of which is optional in the case of this embodiment. Additionally, the electronic page 300 in the case of this embodiment comprises another field 306 in which the employee 3 enters a brief description of his or her project proposal, or at least one keyword describing the project proposal. An appropriate keyword is, for example, a product identifier, when the project proposal is a further development of a product of the industrial enterprise already offered or in planning. If the project proposal is a new product, a keyword can be associated with a product category such as, for example, software or hardware.

The electronic page 300 further comprises another push button 307 underwritten with “Save”, with which, when clicked, a begun project proposal is cached.

With a push button 308 underwritten with “Print”, the employee 3 can print out the completed electronic page 300 with a printer (not more closely shown in the figures).

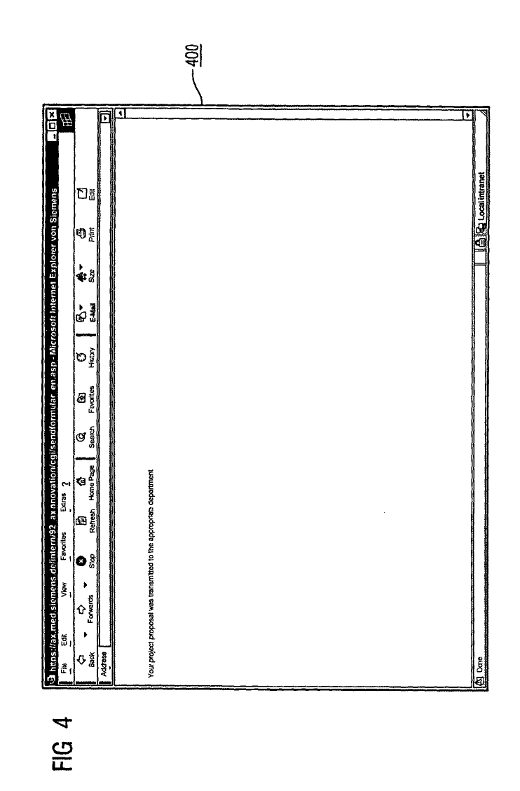

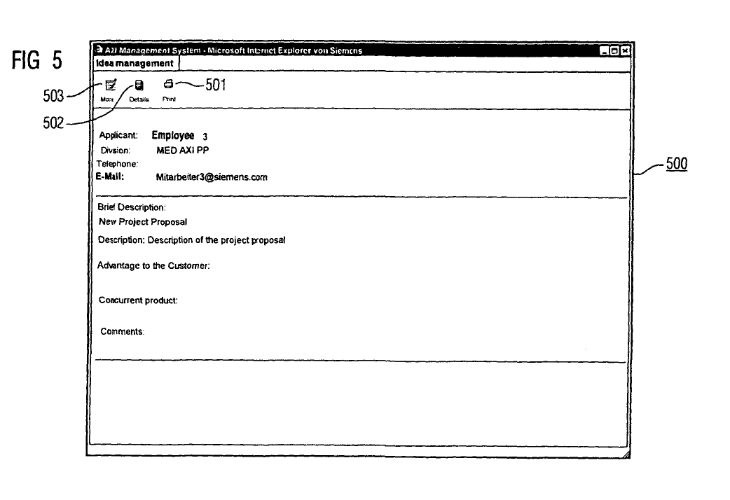

After the employee 3 has filled out the set of fields 301 and the fields 302 and 306, he or she clicks with the computer mouse 11b a push button 308 underwritten with “Confirm”, whereupon an electronic page 400 shown in FIG. 4 automatically appears on the monitor 11a. The electronic page 400 contains a confirmation about the documentation of the project proposal devised by the employee 3. Additionally, the computer program running on the server 2 automatically creates an electronic file that is stored in the server. The entrance page 500 of the electronic file is shown in FIG. 5. The entrance page 500 of the electronic file comprises the specifications for the project proposal made by the employee 3 and transmitted with the completed electronic page 300. In addition, this project proposal is automatically assigned an identification number, which is, e.g., “112” for the present project proposal. The automatic creation of an electronic file is known and requires no further explanation.

The entrance page 500 comprises, in the case of the present exemplary embodiment, a push button 501 underwritten with “Print”, upon the clicking of which the input page 500 is printed, a push button 502 underwritten with “Details”, whose functionality is more closely explained further below, and a push button 503 underwritten with “More”, upon the clicking of which a further input form associated with the following work step for the processing of the project proposal is accessed.

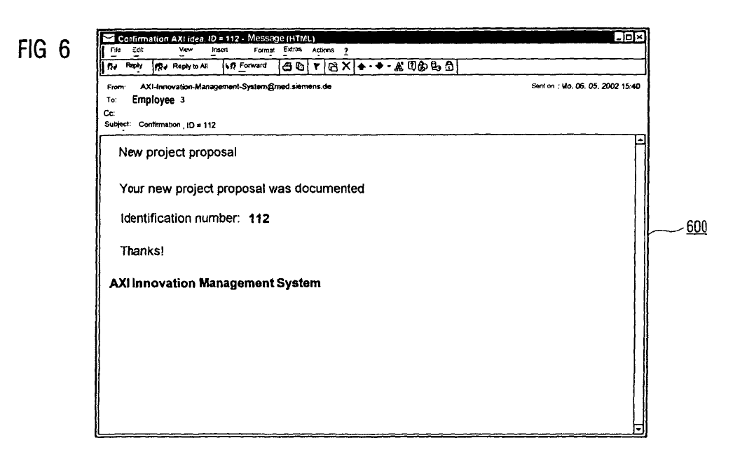

In the case of an exemplary embodiment, with the creation of the electronic file, a generic e-mail 600 shown in FIG. 6 may likewise be generated with a computer program running on the server 2 and sent to the employee 3. The e-mail 600 is a confirmation about the successful documentation of the project proposal of the employee 3.

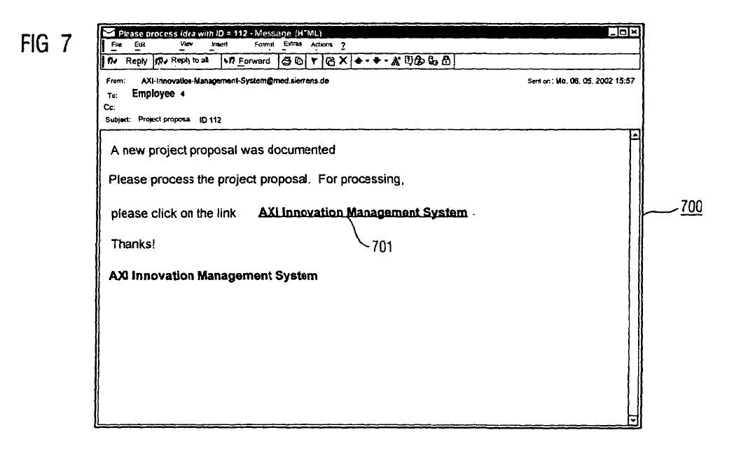

With the creation of the electronic file in the case of the present exemplary embodiment, the electronic file is automatically assigned to one of the employees 4 through 6 that evaluates the project proposal associated with the electronic file and decided whether the project proposal should be further pursued, i.e., realized as a project. The employee 4, 5, or 6 responsible for the evaluation of the project proposal is selected by a further employee of the industrial enterprise based on the statements in the completed field 306. However, in the case of the present exemplary embodiment, a computer program may run on the server 2 that automatically reads out the completed field 306 and, based on predetermined cues or keywords, automatically assigns a newly created electronic file to one of the employees 4, 5, or 6. After the automatic assignment, the computer program running on the server 2 automatically generates an e-mail 700 (shown in FIG. 7) that, in the case of the present exemplary embodiment, is addressed to the employee 4. With the e-mail 700, the employee 4 is informed about the newly created electronic file and thus about the new project proposal. The e-mail 700 additionally comprises a link 701 that points to the electronic file.

After the employee 4 opens the e-mail 700 with a computer 12 connected to the information transmission network 1, and has read it with a monitor 12a connected with the computer 12, he or she clicks on the link 701 (pointing at the electronic file) of the e-mail 700 with a computer mouse 12b connected with the computer 12, whereupon the home page 500 of the electronic file is loaded from the server 2 onto the computer 12.

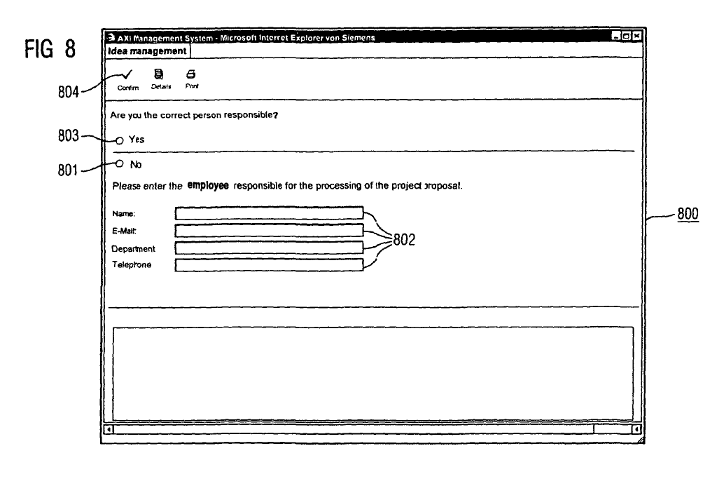

After the employee 4 has read the home page 500 of the examination device, he or she clicks with the computer mouse 12b on the push button 503 (underwritten with “More”) of the home page 500, whereupon an input form 800 (shown in FIG. 8) appears on the monitor 12a, in that it is loaded from the server 2 (in which the input form 800 may be stored) onto the computer 2. Using the input form 800, the employee 4 can confirm whether he or she is the appropriate employee for the evaluation of the project proposal of the electronic file 500.

Should he or she not be responsible for the evaluation, he or she marks a radio button 801 indicated with “No”. Moreover, should he or she know who is responsible for the evaluation, he or she can correspondingly fill out a set of fields 802 of the input form 800, whereupon this employee is automatically notified about the electronic file with an e-mail (not shown in the figures) similar to the e-mail 700. Otherwise, a further employee of the industrial enterprise is notified with an e-mail (not shown in the figures) who thereupon manually assigns the electronic file to the employee 5 or 6.

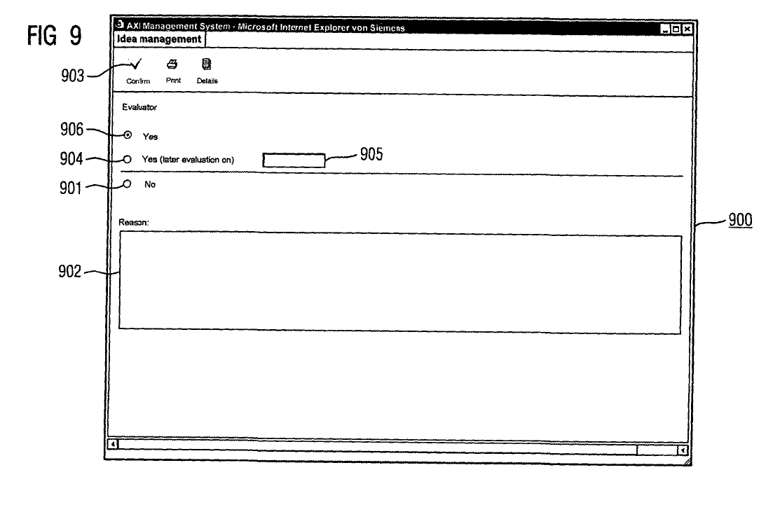

In the case of the present exemplary embodiment, the employee 4 is responsible for the processing of the electronic file, wherefore he or she marks a radio button 803 indicated with “Yes” of the input form 800 and clicks with the computer mouse 12b on a push button 804 underwritten with “Confirm” of the input form 800. An input form 900 shown in FIG. 9 thereupon opens.

With the input form 900, the employee 4 documents whether he or she would like to evaluate the project proposal assigned to the electronic file. If the employee 4 decides against an evaluation of the project proposal, since he or she is of the opinion that the project proposal should not be realized as a project, he or she marks a radio button 901 indicated with “No” of the form 900, and in a field 902 overwritten with “Reason” gives a reason for the rejection.

If the employee 4 decides in principle for an evaluation of the project proposal, but wishes to evaluate it later, he or she marks a radio button 904 indicated with “Yes (later evaluation on)” and gives in a field 905 the date at which he or she would like to begin the evaluation. This event is confirmed with a click on the push button 903 underwritten with “Confirm”.

If the employee 4 decides for a later evaluation and marks the radio button 904, correspondingly fills out the field 905, and confirms his or her decision by clicking on the bush button 903 underwritten with “Confirm”, in the case of an embodiment, a computer program running on the server 2 thus automatically generates on the day that the evaluation should begin an e-mail (not shown in the figures) specifically for the employee 4, with which the employee 4 is reminded of the processing of the project proposal.

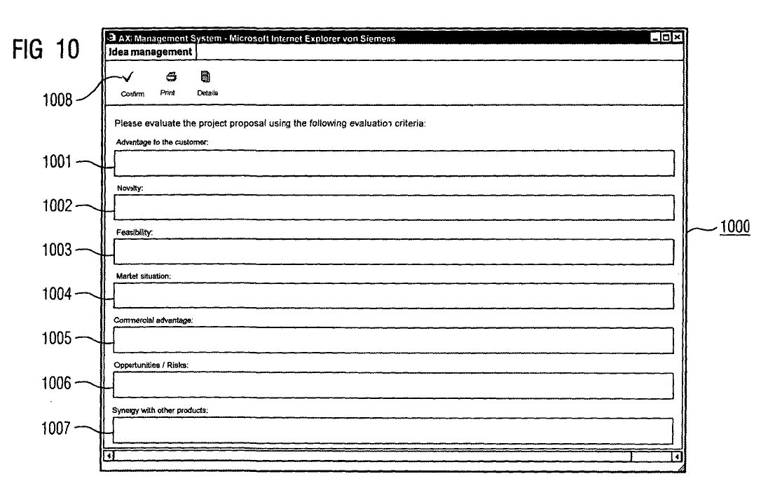

If, as in the case of the present exemplary embodiment, the employee 4 would like to immediately begin the evaluation of the project proposal, he or she marks a radio button 906 indicated with “Yes”, and confirms his or her decision in that he or she clicks on the push button underwritten with “Confirm”. An input form 1000 (shown in FIG. 10) that is loaded from the server 2 onto the computer 12 thereupon appears on the screen 12a.

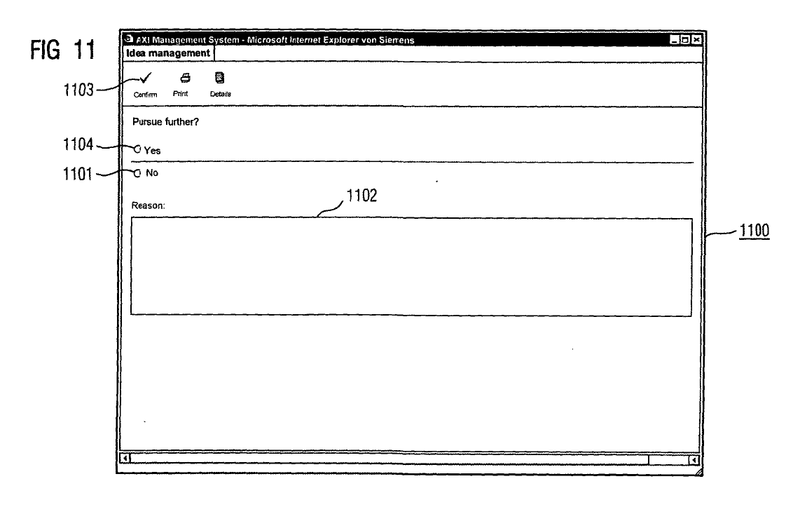

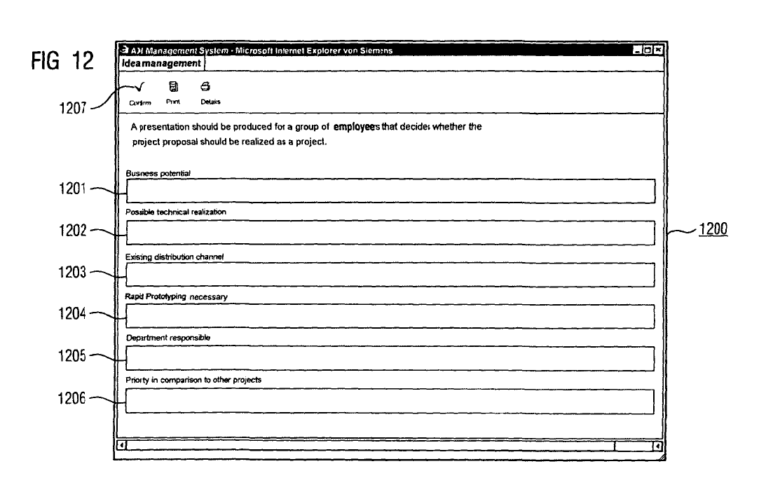

The input form 1000 shown in FIG. 2 has, in the case of the present exemplary embodiment, the form of a checklist for the evaluation of the project proposal. It comprises fields 1001 through 1007, in that the employee 4 fills evaluation criteria into these fields 1001 through 1007. After filling out the fields 1001 through 1007, the employee confirms his or her entries, in that he or she clicks on a push button 1008 underwritten with “Confirm” of the input form 1000. An input form 1100 (shown in FIG. 11) that is loaded from the server 2 onto the computer 12 thereupon appears on the screen 12a.

If the employee is of the opinion, based on his or her evaluation of the project proposal, that the project proposal should not be further pursued as a project, he or she marks a radio button 1101 indicated with “No”, fills out a field 1102 overwritten with “Reason” with a reason for the rejection, and confirms his or her decision, in that he or she clicks upon a push button underwritten with “Confirm” of the input form 1100.

In the case of the present exemplary embodiment, the employee 4 is of the opinion that the project proposal should be realized as a project, wherefore he or she marks a radio button 1104 indicated with “Yes”, and confirms his or her decision by clicking on the push button 1103 underwritten with “Confirm”.

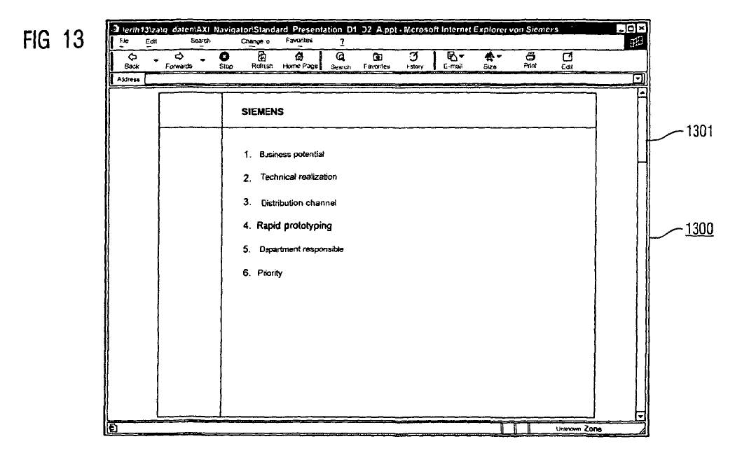

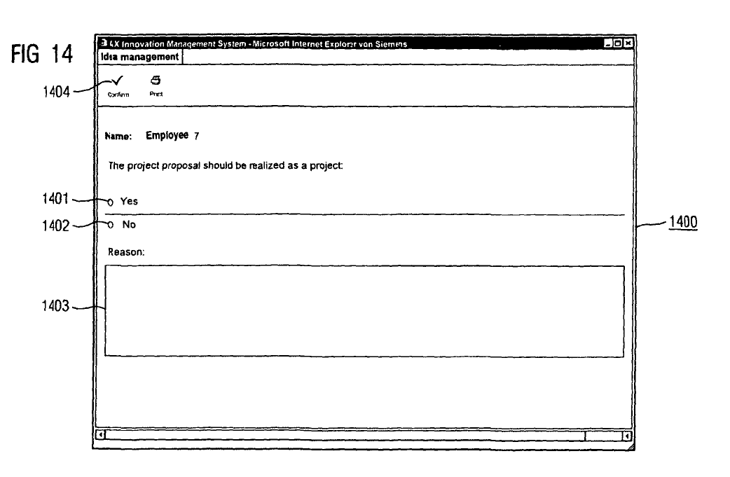

An input form 1200 (shown in FIG. 12) is thereupon loaded onto the computer 12 and appears on the screen 12a. The input form 1200 is therefore provided so that a computer program running on the server 2 generates a set of electronic pages, based on the statements made in the fields 1201 through 1206 of the input form 1200, that can be stored on the server 2 and can be loaded on the computer connected to the information transmission network 1. The set of electronic pages, from which the home page 1300 is shown in FIG. 13, should make it easier for the group of employees (in the case of the present exemplary embodiment, comprising the employees 7 through 10) to decide whether the project proposal that was evaluated by the employee 4 should be realized as a project.

After the employee has filled out the fields 1201 through 1206 of the input form, he or she confirms his or her inputs, in that he or she clicks on a push button 1207 underwritten with “Confirm” of the input form 1200. The work steps to be implemented by the employee 4 are thus ended.

As just specified, the computer program running on the server 2 subsequently generates the set of electronic pages (of which the home page 1300 is shown in FIG. 13) based on the statements made in the fields 1201 through 1206 of the input form 1200. The home page 1300 is, in the case of the present exemplary embodiment, an arrangement of the presentation about the project proposal specific for the employees 7 through 10. The arrangement, in the case of the exemplary embodiment, corresponds to the evaluation criteria associated with the fields 1201 through 1206 of the input form 1200. The further pages (not shown in the figures) of the set of pages comprise, in the case of the exemplary embodiment, the text for each evaluation criterion that the employee 4 input into the corresponding field of the fields 1201 through 1206. The remaining pages can be selected, in that a scroll bar 1301 may be moved in a commonly known manner. Using the presentation about the project proposal, the employees 7 through 10 can decide in a simple manner whether the project proposal should be realized as a project.

So that the employees 7 through 10 are informed about the presentation and the project proposal, a computer program running on the server 2 generates generic e-mails addressed to the employees 7 through 10 that respectively comprise a link to the electronic pages, and in particular to the home page 500. The e-mails specified for the employees 7 through 10 are not shown in the figures, but are similar to the e-mail 700 addressed to the employee 4.

The employees 7 through 10 receive the e-mails directed to the them and open them with computers 13 through 16 connected to the information transmission network 1. Afterwards, they click on the link in their e-mail, whereupon the home page 500 of the electronic file shown in FIG. 5 is loaded from the server 2 on their computers 13 through 16. In order to view the presentation associated with the project proposal, the employees 7 through 10 click upon the push button 502 underwritten with “Details” of the home page 500, whereupon a menu list (not shown in the figures) opens with which, in the case of the present exemplary embodiment, among other things the filled-out input forms 1000 and 1200 and the presentation with the home page 1300 can be selected. The employees 7 through 10 can thus access relevant information and especially presentations about the project proposal specified for them.

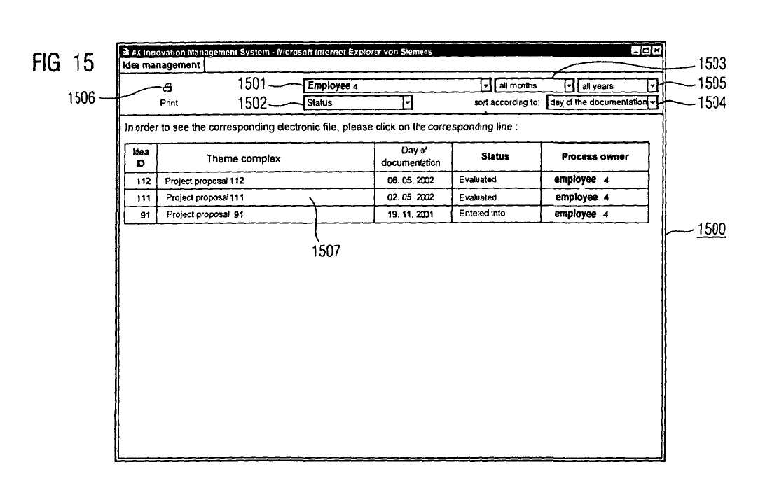

Using the menu list (not shown), the employees 7 through 10 in the case of the exemplary embodiment can access, respectively, an input form 1400 specified for them and shown in FIG. 14. The input form shown in FIG. 14 is, in the case of the present exemplary embodiment, provided for the employee 7.

The input form 1400 comprises a radio button 1402 that the employee 7 can mark if he or she is of the opinion that the project proposal should not be realized as a project. If he or she should mark the radio button 1402 marked with “No”, he or she must also fill out a field 1403 overwritten with “Reason” with a reason for his or her rejection. If the employee 7 is of the opinion that the project proposal should be realized as a project, he or she thus marks the radio button 1401 indicated with “Yes”. The employee 7 confirms his or her decision by clicking on a push button 1404 underwritten with “Confirm”.

If, in the case of the present exemplary embodiment, the majority of the employees 7 through 10 decide for a realization of the project proposal as a project, the next work step of the sequence of work steps is initiated, in that a computer program running on the server 2 generates further e-mails (not shown in the figures) with which further employees of the industrial enterprise are informed about the project proposal. These employees are, in the case of the present exemplary embodiment, within the bounds of the next work step, provided to prepare, e.g., a detailed market study of the project proposal. After the preparation of the market study in the bounds of the ensuing work step, further employees assigned to the next work step are informed about the project proposal. The employees assigned to the current work step for the realization of the project proposal as a project are thus informed in due time about the project proposal via the information transmission network 1, and can request relevant information about the project proposal based on the electronic file via information transmission network 1.

Stored in the server 2 are still further input forms and electronic pages that are associated with further electronic files and are similar to the input forms or, respectively, electronic pages 300 through 1400. The further electronic files are associated with further project proposals. The various electronic files can, in the case of the present exemplary embodiment, be loaded from the server 2 via the electronic page 200 shown in FIG. 2. For this reason, the electronic page 200 comprises a link 202 indicated with “Administration Application”, upon the clicking of which a form 1500 (shown in FIG. 15) is loaded from the server 2 onto the computer with which the form 1500 was requested.

The form 1500, in the case of the present exemplary embodiment, comprises pull-down menus 1501 through 1505 with which, corresponding to the selected entries in the pull-down menus 1501 through 1505, a selection of the documented project proposals are shown, arranged according to their identification numbers. In the case of the present exemplary embodiment, the employee 4 was entered for the pull-down menu 1501, whereupon a list 1507 of all project proposals that were documented within the time span selected with the pull-down menus 1503 and 1505 is shown and submitted for evaluation to the employee 4.

An electronic file associated with the project proposal or, respectively, its input forms and electronic pages can, in the case of the present exemplary embodiment, be selected, in that the corresponding line of the list 1507 is clicked upon. Moreover, the form 1500 can be printed out with a push button 1506 underwritten with “Print”.

After clicking on the line associated with the desired electronic file of the list 1507, the home page associated with the corresponding electronic file is loaded from the server 2 onto the appropriate computer. For example, if the employee selects with the computer 12 the project proposal with the identification number 112, thus the project proposal whose processing was specified above, the home page 500 shown in FIG. 5 and specified above, is loaded from the server 2 onto the computer 12.

In order to obtain detailed information about the electronic file with the home page 500, the employee 4 clicks on the push button 502 underwritten with “Details”, whereupon the menu list (not shown above and in the figures) opens on the computer 12.

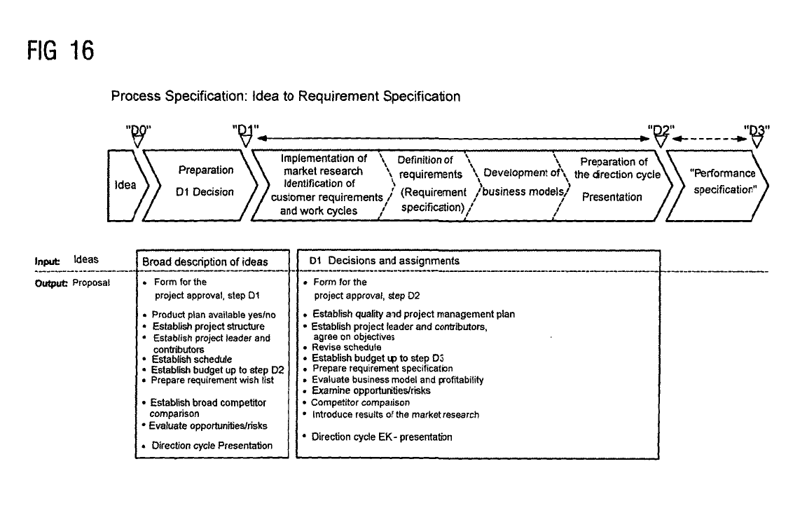

With the menu list, the employee can, among other things, load onto the computer 12 a graphic (shown in FIG. 16) that is imaged on an electronic page stored in the server 2. The graphic visualizes the individually implemented work steps from the beginning of the project proposal with the identification number 112 up to the preparation of a “functional specification” for the realization of the project proposal as a project. The graphic, in the case of the present invention, moreover clarifies which work steps have already been implemented.

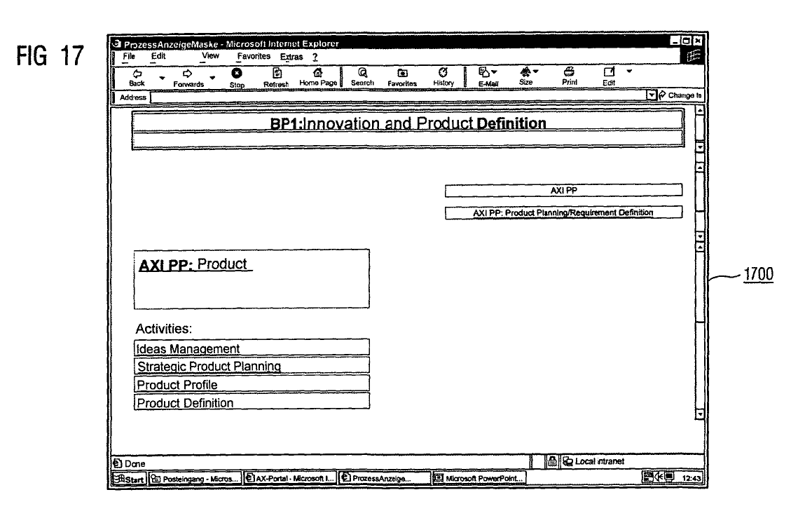

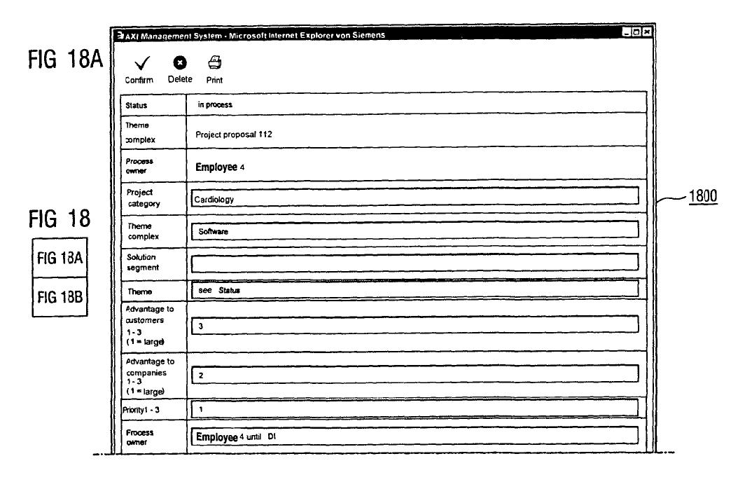

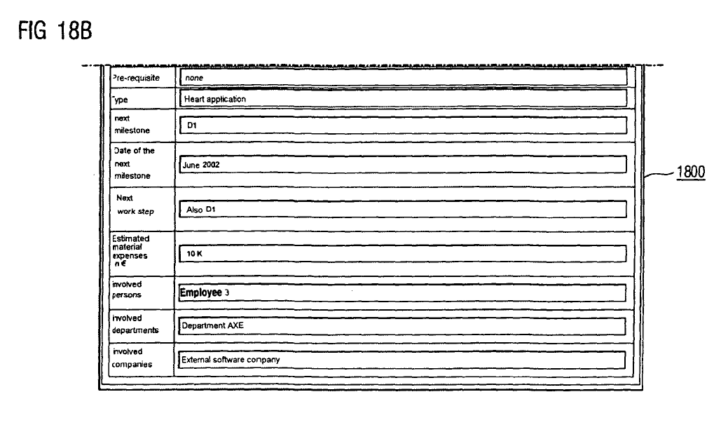

With the menu list accessible by clicking on the push button 502 underwritten with “Details” of the home page 500, in the case of the present exemplary embodiment a further electronic page 1700 (shown in FIG. 17) and an input form 1800 (shown in FIG. 18) are loaded from the server 2 onto the computer 12. The electronic page 1700 is, in the case of the present exemplary embodiment, provided to explain individual work procedures of the work steps. The employee 4 can evaluate a project proposal with the input form 1800.

The specified exemplary embodiment is, for the most part, only to be understood through example.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for a network-supported realization of a project based on a project proposal for the realization of which a sequence of successive work steps to be implemented is provided, comprising:
providing a first electronic page that can be loaded from a first computer with a second computer via an information transfer network, the first electronic page comprising a field in which a project proposal can be entered with the second computer,
automatically creating an electronic file comprising the project proposal;
registering the project proposal in the field;
automatically producing a first electronic message about the electronic file;
automatically transmitting the first electronic message to a first person;
assigning the electronic file to a second person from a first group of people;
automatically producing a second electronic message about the electronic file;
automatically transmitting the second electronic message to the second person;
automatically producing a further electronic message about the electronic file; and
automatically transmitting the further electronic message to a further person or a further group of people that should implement a sequence work step following a preceding implemented work step.

2. A method for network-supported realization of a project based on a project proposal for the realization of which a sequence of successive work steps to be implemented is provided, comprising:
providing a first electronic page that can be loaded from a first computer with a second computer via an information transfer network, the first electronic page comprising a field in which a project proposal can be entered with the second computer;
automatically creating an electronic file comprising the project proposal;
registering the project proposal in the field;
automatically assigning the electronic file to a person from a first group of people;
automatically producing a second electronic message about the electronic file;
automatically transmitting the second electronic message to the person that implements the first work step of the sequence of work steps;
automatically producing a further electronic message about the electronic file; and
automatically transmitting the further electronic message to a further person or a further group of people that should implement a work step of the sequence of work steps that follows a preceding implemented work step.

3. The method according to claim 1, further comprising:
augmenting the electronic file during at least one of the work steps.

4. The method according to claim 2, further comprising:
augmenting the electronic file during at least one of the work steps.

5. The method according to claim 1, further comprising:
summarizing the work steps to be implemented of the sequence of work steps to be implemented on a second electronic page.

6. The method according to claim 2, further comprising:
summarizing the work steps to be implemented of the sequence of work steps to be implemented on a second electronic page.

7. The method according to claim 5, wherein the second electronic page comprises a piece of information about the current work step to be implemented.

8. The method according to claim 6, wherein the second electronic page comprises a piece of information about the current work step to be implemented.

9. The method according to claim 1, further comprising:
preparing at least a third electronic page that comprises an instruction for at least one work step of the sequence of work steps.

10. The method according to claim 2, further comprising:
preparing at least a third electronic page that comprises an instruction for at least one work step of the sequence of work steps.
